(19) United States
(12) Patent Application Publication
(10) Pub. No.: US 2005/0094303 A1
(43) Pub. Date: May 5, 2005

(54) Flying height monitor with servo AGC voltage for write operation in a hard disk drive

(76) Inventor: Tom Chan, San Marino, CA (US)

Correspondence Address: IRELL & MANELLA LLP, 840 NEWPORT CENTER DRIVE, SUITE 400, NEWPORT BEACH, CA, 92660, US

(21) Appl. No.: 10/702,401

(22) Filed: Nov. 4, 2003

(51) Int. Cl. G11B 19/04; G11B 21/02

(52) U.S. Cl. 360/60; 360/75

(57) ABSTRACT

A disk drive that monitors a fly height of a head and disables a write element if the fly height extends beyond a threshold. The head is coupled to an amplifier that is controlled by a control signal from an automatic gain control. The control signal varies proportionally with the fly height of the head. An increase in fly height will reduce the amplitude of the signal read by the head. To compensate for the weaker signal the gain control increases the control signal and the gain of the amplifier. The drive further contains a controller that monitors the control signal generated by the automatic gain control. If the control signal extends beyond a threshold value, indicative of an excessive fly height, the controller inhibits the write element so that data cannot be written onto a disk.

### BACKGROUND OF THE INVENTION

1. Field of the Invention

The present invention relates to a method for disabling a write element of a hard disk drive by monitoring the flying height of a head through the control signal of an automatic gain control circuit.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

The disks are rotated by a spindle motor of the drive. Rotation of the disks creates an air flow within the disk drive. Each head has an air bearing surface that cooperates with the air flow to create an air bearing between the head and the adjacent disk surface. The air bearing eliminates or minimizes the mechanical wear between the head and the disk. The height of the air bearing is commonly referred to as the flying height of the head.

The magnetic field detected by the head is inversely proportional to the flying height of the head. Likewise, the strength of the magnetic field written onto the disk is also inversely proportional to the fly height. A larger fly height will produce a weaker magnetic field on the disk.

Due to various reasons the fly height of the heads may vary during operation of the drive. Such a variation in fly height may result in poorly written data on the disk. Weakly written data may create errors during a read routine. It would be desirable to monitor the fly height of the heads to prevent write operations when the height is at an undesirable level. It would also be desirable to provide such a monitoring function without significantly changing the components, cost, or operation of the drive.

### BRIEF SUMMARY OF THE INVENTION

A hard disk drive with a controller that monitors a control signal for an automatic gain control circuit of the drive. The controller inhibits a write element of a head if the control signal extends beyond a threshold.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical circuit for the hard disk drive;

FIG. 4 is a schematic showing function blocks of a read channel of the drive;

FIG. 5 is a timing diagram showing the inhibition of a write element;

FIG. 6 is a flowchart showing a process for monitoring a fly height and disabling a write element if the fly height exceeds a threshold.

### DETAILED DESCRIPTION

Disclosed is a disk drive that monitors a fly height of a head and disables a write element if the fly height extends beyond a threshold. The head is coupled to an amplifier that is controlled by a control signal from an automatic gain control. The control signal varies proportionally with the fly height of the head. An increase in fly height will reduce the amplitude of the signal read by the head. To compensate for the weaker signal the gain control increases the control signal and the gain of the amplifier. The drive further contains a controller that monitors the control signal generated by the automatic gain control. If the control signal extends beyond a threshold value, indicative of an excessive fly height, the controller inhibits the write element so that data cannot be written onto a disk.

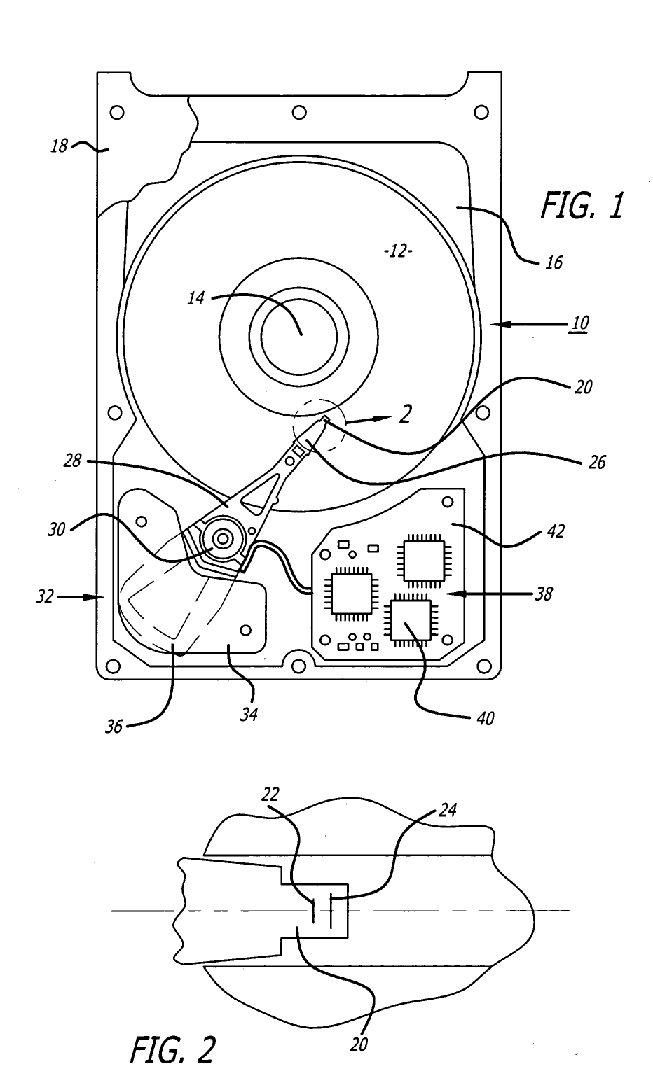

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

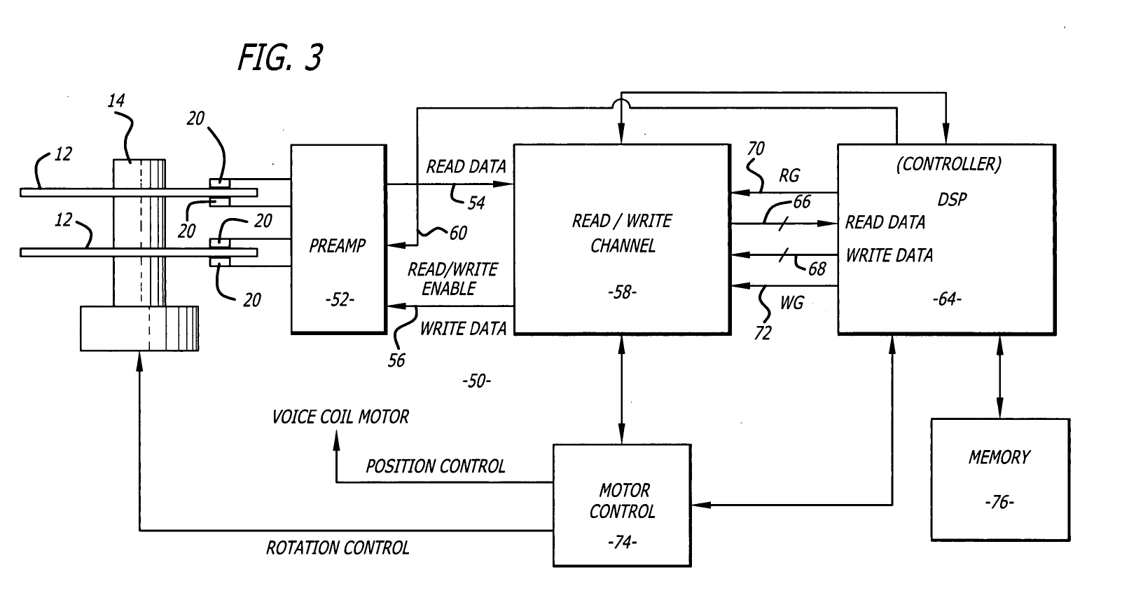

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

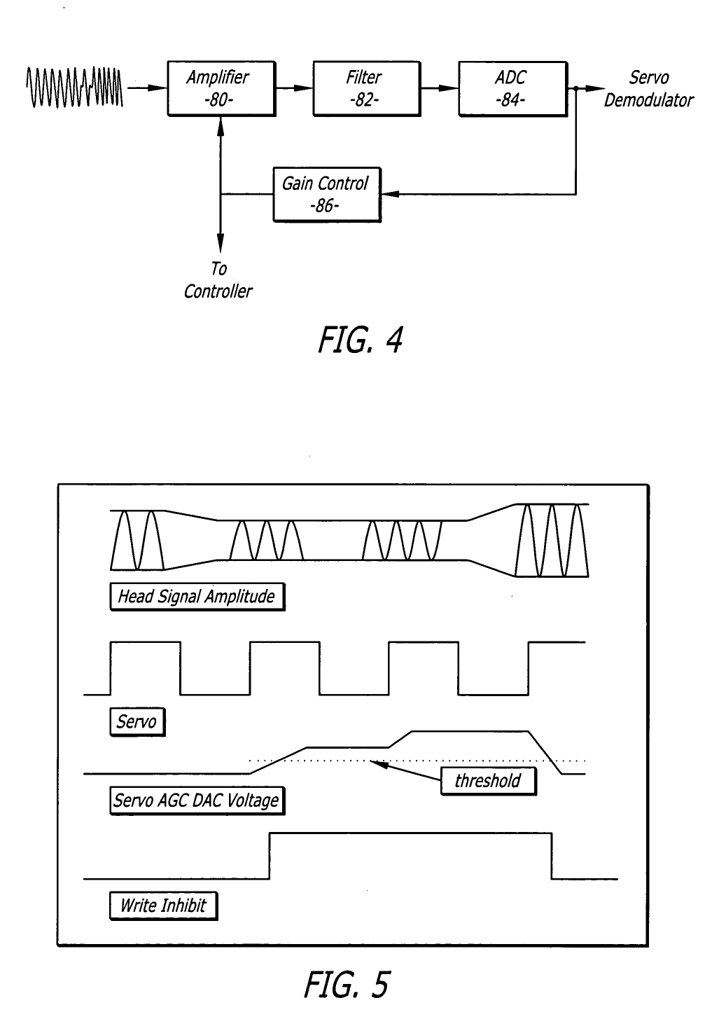

FIG. 4 is a schematic showing functional blocks of a read channel and pre-amp of the disk drive. The read channel includes an amplifier 80 coupled to a head(s)(not shown). The amplifier 80 adjusts the amplitude of a signal read by the head. The amplified signal is filtered by filter 82 and converted to a digital bit string by an analog to digital (“ADC”) converter 84.

The gain of the amplifier 80 is adjusted by an automatic gain control circuit 86. The automatic gain control circuit 86 receives as input the digital output of the ADC 84 and provides an analog control signal to the amplifier 80.

The control signal is inversely proportional to the amplitude of the read signal. A weak signal will result in a larger control signal. A larger control signal will increase the gain of the automatic gain control circuit and boost the amplitude of the read signal. The signal read by the head is inversely proportional to the head fly height. Consequently, the control signal is proportional to the fly height. A larger control signal is indicative of an increasing fly height.

The controller 64 monitors the control signal generated by the automatic gain control circuit 86. The controller 64 compares the value of the control signal with a threshold value. If the control signal exceeds the threshold, indicative of an undesirable fly height, the controller inhibits the write gate and write element from writing data onto the disk. This is graphically shown by the timing diagram in FIG. 5. If the control signal does not exceed the threshold, the controller 64 allows for a write operation onto the disk.

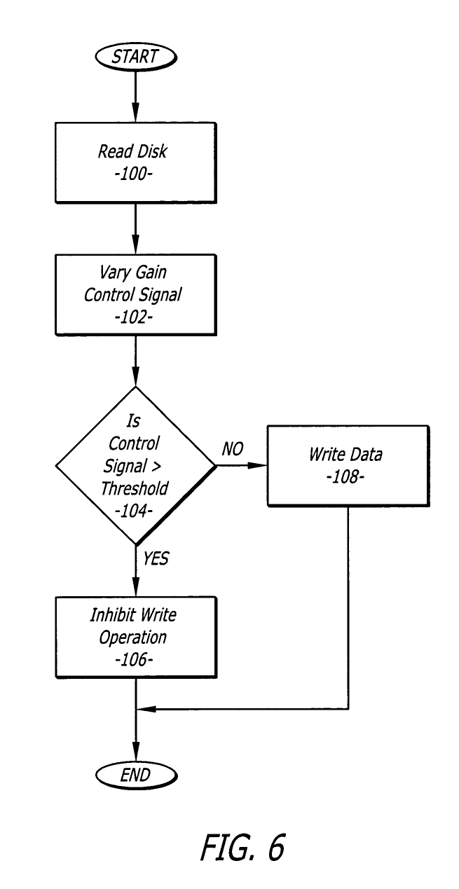

FIG. 6 is a flowchart showing a method for monitoring and disabling a write element when a fly height exceeds a threshold level. In block 100 the head reads a track of the disk. This reading process preferably occurs in the servo section of a track sector. The servo section typically contains a plurality of servo bits used to center the head on the track. The reading of servo is also shown in the timing diagram depicted in FIG. 5.

In block 102 the gain control signal is varied to change the gain of the amplifier. The controller reads and compares the adjusted control signal with a threshold value in decision block 104. If the control signal exceeds the threshold then the write gate is inhibited in block 106. If the control signal does not exceed the threshold then the controller allows for a write operation in block 108. The threshold may be set at a value that corresponds to a maximum allowable flying height for the head.

By monitoring the gain control signal the controller can monitor variations in fly height and prevent undesirable write operations without adding components and cost to the disk drive.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A hard disk drive, comprising:
a disk;
a head coupled to said disk, said head having a write element;
an amplifier coupled to said head;
an automatic gain control circuit coupled to said amplifier, said automatic gain control circuit provides a control signal to said amplifier; and,
a controller coupled to said head and said automatic gain control circuit, said controller inhibits said write element if said control signal extends beyond a threshold.

2. The disk drive of claim 1, wherein said automatic gain control circuit is coupled to a digital to analog converter.

3. The disk drive of claim 1, wherein said threshold corresponds to a maximum flying height of said head.

4. The disk drive of claim 1, wherein said write element is disabled if said control signal exceeds the threshold.

5. The disk drive of claim 1, wherein said controller monitors said control signal to disable said write element when said head reads a servo section of said disk.

6. A hard disk drive, comprising:
a disk;
head means for generating a read signal from said disk;
amplifier means for amplifying said read signal at a gain;
automatic gain control circuit means for controlling said gain of said amplifier with a control signal; and,
controller means for inhibiting a write operation on said disk if said control signal extends beyond a threshold.

7. The disk drive of claim 6, wherein said control circuit means includes a digital to analog converter.

8. The disk drive of claim 6, wherein said threshold corresponds to a maximum flying height of said head.

9. The disk drive of claim 6, wherein said write operation is inhibited if said control signal exceeds the threshold.

10. The disk drive of claim 6, wherein said controller means monitors said control signal to inhibit said write operation when said head reads a servo section of said disk.

11. A program storage medium that contains a program for a hard disk drive, the hard disk drive having a head coupled to an amplifier and an automatic gain control circuit that provides a control signal to the amplifier, comprising:
a program storage medium that contains a program which causes a controller to monitor the control signal and inhibit a write operation if the control signal extends beyond a threshold.

12. The medium of claim 11, wherein the write operation is inhibited if the control signal is below a threshold value.

13. The medium of claim 11, wherein said program causes the controller to monitor the control signal to inhibit the write operation when the head reads a servo section of a disk.

14. A method to disable a write operation of a head by monitoring a flying height of the head, comprising:
reading a signal from a disk through a head;
adjusting a gain of an amplifier that amplifies the signal with a control signal derived from the signal; and,
inhibiting a write operation if the control signal extends beyond a threshold.

15. The method of claim 14, wherein the signal is converted into a digital bit string.

16. The method of claim 14, wherein the control signal is an analog signal.

17. The method of claim 14, wherein the write operation is inhibited if the control signal exceeds the threshold.

18. The method of claim 14, wherein the signal is read from a servo section of a disk.
